(19) United States
(12) Patent Application Publication
(10) Pub. No.: US 2009/0112452 A1
(43) Pub. Date: Apr. 30, 2009

(54) VEHICLE NAVIGATION SYSTEM WITH REAL TIME TRAFFIC IMAGE DISPLAY

(75) Inventors: M. SCOTT BUCK, COMMERCE TOWNSHIP, MI (US); BECHARA NAJM, NOVI, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 11/924,372

(22) Filed: Oct. 25, 2007

(51) Int. Cl. G06F 17/00; G01C 21/30

(52) U.S. Cl. 701/117; 340/988; 701/208

(57) ABSTRACT

Methods and apparatus are provided for displaying traffic status information to a user of a vehicle. An onboard vehicle methodology as described herein receives traffic image data corresponding to a picture of a road section, and displays the picture of the road section on an onboard display element of the vehicle.

### TECHNICAL FIELD

The subject matter described herein generally relates to onboard operator display systems for vehicles, and more particularly relates to an onboard system that displays real time traffic images.

### BACKGROUND

A vehicle navigation system generally provides navigation instructions, location data, and map information to the vehicle operator. The prior art is replete with vehicle navigation systems that attempt to optimize a route based upon different factors. Route calculation is typically performed by examining a number of possible paths, and selecting the “best” path according to a number of optimization rules. For instance, the shortest possible route may be chosen to minimize the distance traveled or high-speed roads may be chosen to minimize travel time. After the optimization criteria have been selected, automated vehicle route guidance is typically performed in a two-step process: (1) a proposed route is calculated from the current position of the vehicle to the desired destination; and (2) guidance instructions are presented to the vehicle operator as the vehicle traverses the proposed route.

Some advanced navigation systems utilize traffic congestion data in an attempt to generate a proposed route that guides the vehicle away from traffic jams. Moreover, some vehicle navigation systems are able to display a simple graphical representation (such as a colored icon or a bar graph) of the level of traffic congestion at specified intersections or road segments. For example, a road segment or an intersection displayed on the onboard screen may be colored green if traffic is flowing smoothly, yellow if traffic congestion is moderate, or red if traffic congestion is severe. Although such graphical indicators can be helpful, the underlying traffic congestion data may be delayed. Moreover, such graphical indicators do not provide an accurate depiction of the actual traffic condition of the road, highway, or freeway upon which the vehicle is traveling.

### BRIEF SUMMARY

An method is provided for displaying traffic status information to a user of a vehicle. The method involves receiving traffic image data corresponding to a picture of a road section, and displaying the picture of the road section on an onboard display element of the vehicle.

An alternate method is also provided for displaying traffic status information to a user of a vehicle. This method involves storing a plurality of road section images corresponding to a respective plurality of different road sections, selecting one of the plurality of road section images, resulting in a selected road section image, and displaying the selected road section image on an onboard display element of the vehicle.

A traffic status system for a vehicle is also provided. The system includes a data communication module configured to receive traffic image data indicative of a picture of a road section, a display driver coupled to the data communication module, the display driver being configured to process the traffic image data for display, and a display element coupled to the display driver, the display element being configured to display the picture of the road section.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### DESCRIPTION OF THE DRAWINGS

At least one embodiment of the present invention will hereinafter be described in conjunction with the following drawing figures, wherein like numerals denote like elements, and

FIG. 1 is a schematic representation of an embodiment of a traffic status system architecture for a vehicle;

FIG. 2 is a schematic representation of an embodiment of an onboard traffic status system;

FIG. 3 is a face view of an onboard unit having displayed thereon an exemplary navigation map;

FIG. 4 is a face view of the onboard unit shown in FIG. 3 having displayed thereon an exemplary navigation map and a picture of a road section superimposed over the navigation map; and

FIG. 5 is a flow chart that illustrates an embodiment of a traffic status display process.

### DESCRIPTION OF AN EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

Techniques and technologies may be described herein in terms of functional and/or logical block components and various processing steps. It should be appreciated that such block components may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments may be practiced in conjunction with any number of data transmission protocols and that the system described herein is merely one suitable example.

For the sake of brevity, conventional techniques related to signal processing, image processing, data transmission, general vehicle navigation system operation, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the subject matter.

The following description refers to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically.

A system as described herein can be used to enhance onboard vehicle navigation systems by incorporating realtime or near realtime images obtained from traffic cameras. While the onboard display element is displaying the current road (or route while within a navigational direction), the system will determine when the vehicle is approaching a traffic camera. The image of the current traffic pattern captured by that traffic camera is displayed in a viewing window as a static image showing the traffic conditions that the driver is approaching. The image is displayed well enough in advance of the actual road section to allow the driver to make the decision to change the current route if necessary to avoid traffic congestion. The road section images can be delivered to the vehicle via wireless data communication technologies, e.g., cellular or satellite technology. The onboard system will request image data based upon the availability of traffic camera data (provided by, for example, the Department of Transportation) and based upon the current vehicle location. The vehicle location can be determined via a global positioning system, proximity to cellular network transmitters, or the like. The traffic image display can be turned on or off via configuration settings of the onboard display unit.

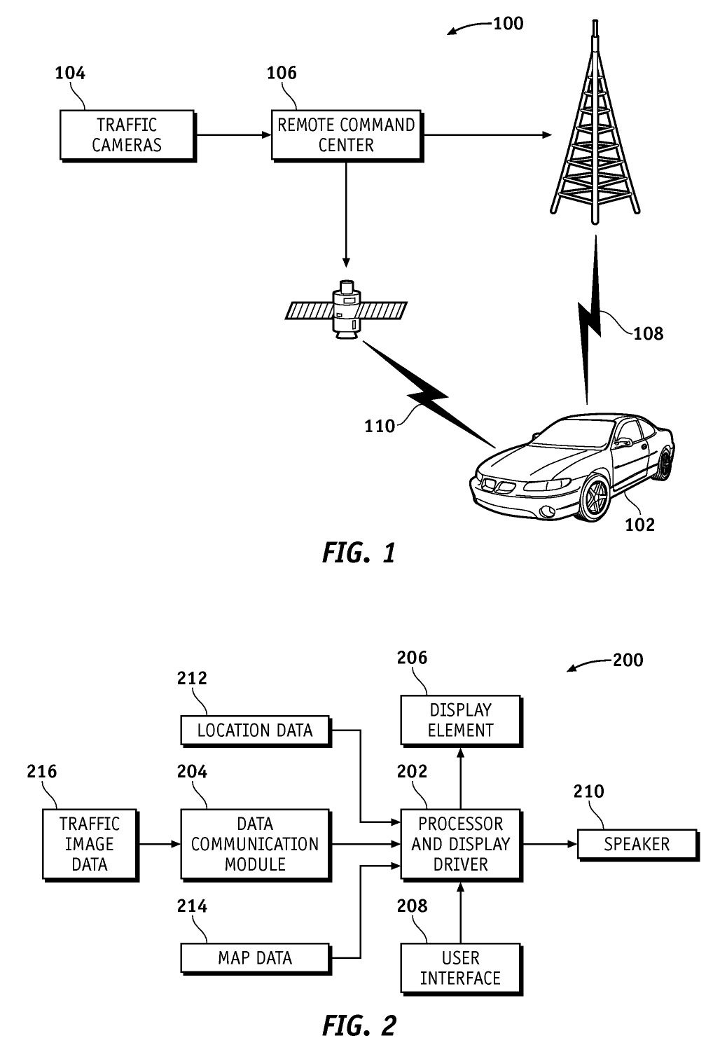

FIG. 1 is a schematic representation of an embodiment of a traffic status system architecture 100 for one or more vehicles, such as a vehicle 102. For simplicity and ease of description, only one vehicle 102 is depicted in FIG. 1. In practice, system architecture 100 can support any number of vehicles, subject to realistic operating limitations such as bandwidth, power restrictions, and wireless data transmission ranges. System architecture 100 generally includes, without limitation: one or more traffic cameras 104; at least one remote command center 106; and an onboard traffic status system carried by vehicle 102.

Each of the traffic cameras 104 represents a source of traffic image data for system architecture 100. A traffic camera 104 may be realized as an analog or digital still camera, an analog or digital video camera, or any device or apparatus that is suitably configured to capture traffic image data indicative of a picture of a respective road section. System architecture 100 preferably includes a plurality of traffic cameras 104 strategically located at different road sections, intersections, offramps, onramps, or other points of interest. Each traffic camera 104 is suitably configured to capture traffic image data in realtime or substantially realtime such that system architecture 100 can process and deliver updated pictures of the road sections, intersections, offramps, onramps, or other points of interest to vehicle 102 as needed. For the embodiment described herein, each traffic camera 104 is positioned in a known and stationary location.

Traffic cameras 104 are coupled to remote command center 106 via one or more data communication networks (not shown). For this embodiment, traffic cameras 104 capture traffic image data and transmit the traffic image data to remote command center 106 using the data communication network(s), wired communication links, and/or wireless communication links. In this regard, traffic cameras 104 may communicate with remote command center 106 using data communication links carried by a cellular service provider, and the data communication network may, for example, represent a cellular telecommunication network, the Internet, a LAN, a WAN, a satellite communication network, any known network topology or configuration, portions thereof, or any combination thereof. In practice, system architecture 100 and traffic cameras 104 can be suitably configured to support practical operating parameters related to image resolution, data compression, data transmission rate, image refresh/update rate, or the like.

For certain embodiments, remote command center 106 is associated with a telematics system that supports vehicle 102. In this regard, telematics systems support data communication (usually wireless) between one or more onboard vehicle systems and a remote command center, entity, network, or computing architecture. Telematics systems typically support bidirectional data transfer such that the remote command center can provide services to the user of the vehicle, upgrade software-based vehicle components, receive diagnostic vehicle data for storage and/or processing, receive emergency calls from a user of the vehicle, etc. Telematics systems are capable of tracking the current locations of compatible vehicles using satellite-based global positioning system (GPS) technology. Telematics systems are well known to those familiar with the automotive industry, and as such they will not be described in detail here.

Remote command center 106 is suitably configured to receive the traffic image data from traffic cameras 104, process the traffic image data if needed for resizing, formatting, data compression, etc., and transmit the traffic image data (and/or processed traffic image data) to vehicle 102. As described in more detail below, remote command center 106 is responsible for providing still images of monitored road sections to vehicle 102. Remote command center 106 is coupled to vehicle 102 via one or more data communication networks (not shown). In this regard, remote command center 106 may utilize data communication links carried by a cellular service provider and/or a satellite service provider, and the data communication network may, for example, represent a cellular telecommunication network, the Internet, a LAN, a WAN, a satellite communication network, any known network topology or configuration, portions thereof, or any combination thereof. FIG. 1 depicts a typical deployment that supports cellular data communication 108 between remote command center 106 and vehicle 102 and/or satellite data communication 110 between remote command center 106 and vehicle 102. In practice, the data communication between vehicle 102 and its host remote command center 106 may be performed in accordance with wireless data communication protocols other than cellular and satellite, such as, without limitation: BLUETOOTH® wireless data communication or IEEE 802.11 (any applicable variant).

In certain embodiments, system architecture 100 employs a call-response methodology, where traffic image data is downloaded to vehicle 102 in response to calls initiated by vehicle 102. In this regard, such a call represents a request for updated traffic data, and the request is transmitted from vehicle 102 to remote command center 106. These requests can be manually initiated or automatically initiated according to a desired schedule. This call-response methodology is desirable to enable system architecture 100 to manage data traffic, wireless data communication resources, and other practical operating parameters.

FIG. 2 is a schematic representation of an embodiment of an onboard traffic status system 200. For this example, system 200 is deployed in vehicle 102. In practice, system 200 may be implemented as part of an onboard vehicle navigation system, an onboard vehicle entertainment system, an onboard display system, an onboard vehicle instrumentation cluster, or the like. The illustrated embodiment of system 200 includes, without limitation: a processor 202; a data communication module 204 coupled to processor 202; a display element 206 coupled to processor 202; a user interface 208 coupled to processor 202; and at least one speaker 210 coupled to processor 202. In practice, the various components are coupled to processor 202 in a manner that facilitates the communication of data, instructions, control signals, and possibly other signals to and from processor 202. Of course, a practical system 200 may include additional components configured to perform conventional functions that are unrelated to the invention.

Generally, processor 202 is configured to perform or otherwise support the various operations and functions described herein. In particular, processor 202 may include, cooperate with, or be realized as a display driver for system 200. This display driver is suitably configured to process traffic image data for display at display element 206. In this embodiment, processor 202 obtains location data 212 from an appropriate source that provides data indicative of the current vehicle location or position. In one practical embodiment, the location data source is realized as an onboard GPS receiver/processor that derives the current position of the vehicle from GPS data received by the vehicle in realtime or substantially realtime. It should be appreciated that the location data source, processor 202, and any corresponding logical elements, individually or in combination, are exemplary means for obtaining a location data corresponding to the current location of the host vehicle.

Processor 202 is also configured to obtain map data 214 from an appropriate source that provides data indicative of current cartographic, topological, location, road, and possibly other data useful to system 200. Map data 214 can represent locally stored, cached, downloaded, or accessible information, which can be processed by processor 202. For example, in a fully onboard implementation, the map data source(s) may be realized as one or more hard disks, semiconductor memory devices, portable storage media, or the like. In an alternate embodiment, the map data source(s) may be realized as an onboard memory cache that temporarily stores map data 214 that is downloaded from remote databases. As described in more detail below, processor 202 can access map data 214 to determine the distances between the vehicle and the traffic cameras.

Processor 202 is also configured to obtain traffic image data 216 that conveys realtime or near-realtime pictures of approaching road segments, intersections, or other points of interest. For this embodiment, traffic image data 216 is received by one or more data communication modules 204. For simplicity, the example described here employs one data communication module 204. Data communication module 204 is suitably configured to support data communication between system 200 and the host remote command center (see FIG. 1). Here, data communication module 204 is configured to support wireless data communication, and data communication module 204 can support one or more wireless data communication protocols such as, without limitation: satellite data communication protocols; cellular telecommunication protocols; RF; IrDA (infrared); Bluetooth; ZigBee (and other variants of the IEEE 802.15 protocol); IEEE 802.11 (any variation); spread spectrum; frequency hopping; wireless/cordless telecommunication protocols; wireless home network communication protocols; paging network protocols; magnetic induction; GPRS; and proprietary wireless data communication protocols.

As described in more detail herein, data communication module 204 is suitably configured to receive traffic image data that conveys pictures of different road sections in realtime or approximately realtime. Moreover, system 200 utilizes data communication module 204 to transmit requests for updated traffic image data from the vehicle to the host remote command center.

Display element 206, speaker 210, and user interface 208 may be configured in accordance with conventional vehicle navigation, information, or instrumentation systems to enable onboard interaction with the vehicle operator. Display element 206 may be a suitably configured LCD, plasma, CRT, or head-up display, which may or may not be utilized for other vehicle functions. In accordance with known techniques, the display driver can provide rendering control signals to display element 206 to cause display element 206 to render maps, proposed routes, roads, navigation direction arrows, traffic camera icons, pictures of road sections, and other graphical elements as necessary to support the function of system 200. The display driver is also suitably configured to remove pictures of road sections from display element 206 after a designated time period (e.g., a temporary display period). It should be appreciated that display element 206 and any corresponding logical elements, individually or in combination, are example means for providing navigation instructions for a proposed route.

Speaker 210 may be devoted to system 200, it may be realized as part of the audio system of the vehicle, or it may be realized as part of another system or subsystem of the vehicle. Briefly, speaker 210 may receive audio signals from processor 202, where such audio signals convey navigation instructions, user prompts, warning signals, and other audible signals as necessary to support the function of system 200.

User interface 208 is configured to allow the vehicle operator to enter data and/or control the functions and features of system 200. For example, the operator can manipulate user interface 208 to enter a starting location and a destination location for the vehicle, where the starting and destination locations are utilized by system 200 for purposes of route planning. If the desired starting location corresponds to the current vehicle location, then the operator need not enter the starting location if system 200 includes a source of current vehicle position information. An operator can manipulate user interface 208 to enter settings, preferences, and/or operating parameters associated with the traffic image display functionality of system 200. For example, user interface 208 enables an operator to: turn the traffic image display function on or off; designate a threshold distance (between the vehicle and a traffic camera) that triggers the display of a road section image; and designate a time period that governs how long each road section image remains on display element 206. User interface 208 may be realized using any conventional device or structure, including, without limitation: a keyboard or keypad; a touch screen (which may be incorporated into display element 206); a voice recognition system; a cursor control device; a joystick or knob; or the like.

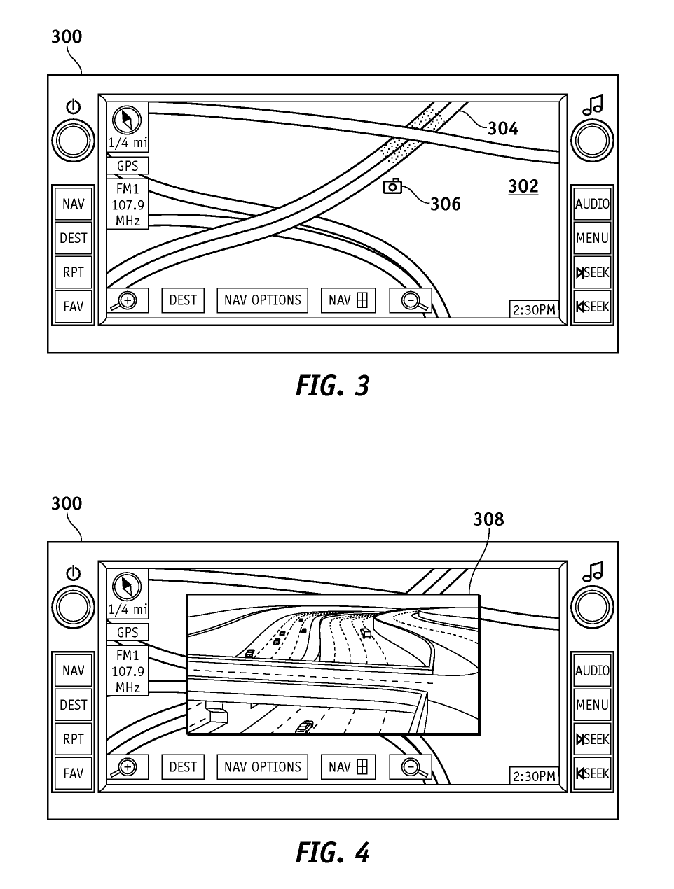

FIG. 3 is a face view of an onboard unit 300 having displayed thereon an exemplary navigation map image 302. Onboard unit 300 represents one possible device suitable for use with system 200, and navigation map image 302 represents one possible screen shot that might appear during operation of system 200. In practice, an embodiment of system 200 will be capable of generating a vast number of different map screens using any suitable device configuration and display element configuration.

Navigation map image 302, which may be rendered as a two dimensional graphic or picture or a three dimensional graphic or picture, may identify streets, freeways, roads, highways, intersections, points of interest, or other features commonly found on paper maps, online mapping websites, or vehicle navigation system displays. In this regard, navigation map image 302 may include alphanumeric text labels that identify streets, roads, intersections, cities, county lines, zip codes, area codes, position coordinates, or the like. Navigation map image 302 may include a graphical feature or graphical icon 304 that identifies a road section of interest. In FIG. 3, the graphical icon 304 is rendered as a visually distinguishable color, shading, stippling, or texture on the road section of interest. Alternatively or additionally, navigation map image 302 may include a graphical feature or graphical icon feature 306 that identifies a location of a traffic camera for the road section of interest. These graphical icons 304/306 allow a user to quickly identify locations of monitored road sections and/or the specific locations of the traffic cameras that generate the road section images processed by the onboard system. Although FIG. 3 depicts only one road section graphical icon 304 and only one traffic camera graphical icon 306, a map screen rendered on onboard unit 300 may include any number of such graphical icons 304/306 or features.

In some embodiments, onboard unit 300 is controlled such that it displays a video image (or a sequence of still images that are rendered to emulate a video clip) of road sections at appropriate times. In preferred embodiments, onboard unit 300 is controlled such that it displays still images (i.e., snapshots) of road sections at appropriate times. In this regard, FIG. 4 is a face view of onboard unit 300 having displayed thereon navigation map image 302 and a picture 308 superimposed over navigation map image 302. The viewing window for picture 308 may be larger or smaller than that shown in FIG. 4, or it may be rendered in a full screen mode. In other embodiments, onboard unit 300 may display a split screen that simultaneously displays both a navigation map image and a traffic camera image. In this manner, onboard unit 300 can be used to show the current location of the vehicle and a picture of the approaching traffic conditions (using a split screen, superimposed images, or the like). In addition, the shape and position of the viewing window for picture 308 may be different than that shown in FIG. 4. Indeed, picture 308 may be rendered in a dynamic manner during operation. For instance, picture 308 may be dynamically displayed such that it always appears near its associated traffic camera graphical icon 306. Moreover, the overlapping portion of picture 308 may completely obscure navigation map image 302 (as shown in FIG. 4), or it may be rendered in a partially transparent manner such that navigation map image 302 remains partially visible.

The content of picture 308 will be determined by the current road conditions, traffic conditions, and/or the state of the monitored point of interest. For example, picture 308 may represent a realtime or near realtime picture of a road section of interest, as depicted in FIG. 4. Picture 308 may alternatively (or additionally) include an image of: an intersection; an onramp; an offramp; a bridge; a highway interchange; a toll booth; a border check; or any point of interest. For the system described herein, picture 308 represents an image of a section of the road upon which the vehicle is currently traveling.

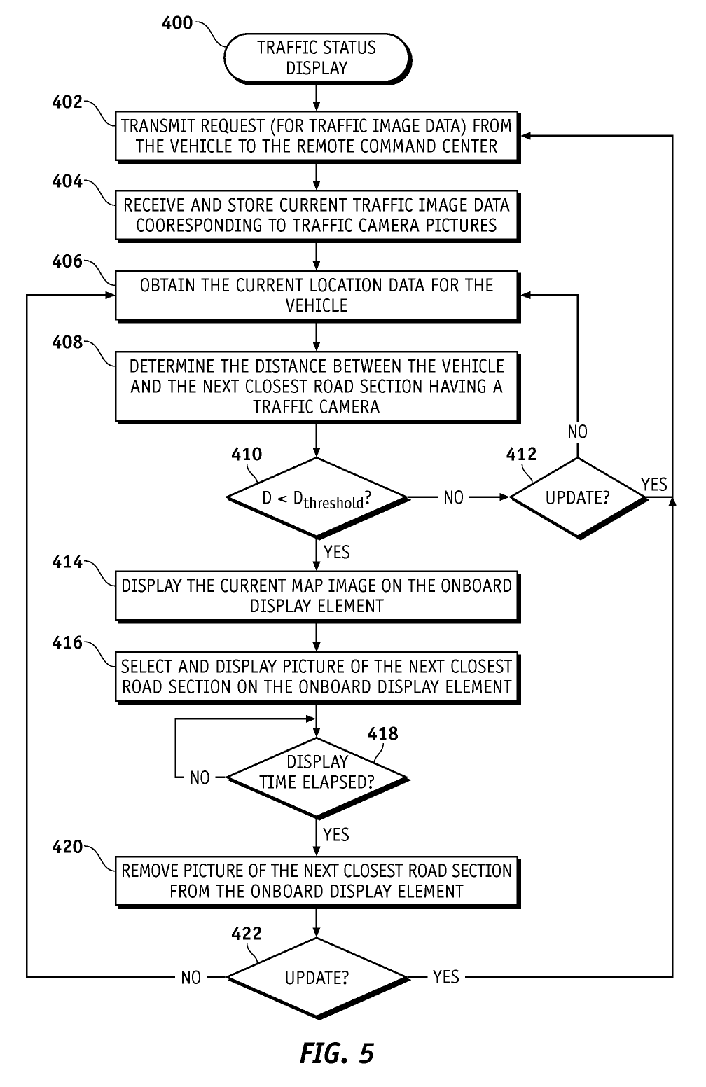

Operation of an exemplary system will now be described with reference to FIG. 5, which is a flow chart that illustrates an embodiment of a traffic status display process 400. The various tasks performed in connection with process 400 may be performed by software, hardware, firmware, or any combination thereof. For illustrative purposes, the following description of process 400 may refer to elements mentioned above in connection with FIGS. 1-3. In practice, portions of process 400 may be performed by different elements of the described system, e.g., traffic cameras 104, remote command center 106, data communication module 204, processor 202, or display element 206. It should be appreciated that process 400 may include any number of additional or alternative tasks, the tasks shown in FIG. 5 need not be performed in the illustrated order, and process 400 may be incorporated into a more comprehensive procedure or process having additional functionality not described in detail herein.

A system that supports traffic status display process 400 preferably includes a plurality of traffic cameras that capture realtime or near realtime images utilized by the system. In addition, a system that supports process 400 preferably includes at least one remote command center that collects the images captured by the traffic cameras, processes the images if necessary, and transmits the images as needed to the vehicles serviced by the remote command center. Thus, concurrently with process 400, the traffic cameras capture road section images at a plurality of different road sections, and the road section images are transmitted to one or more remote command centers. For simplicity, process 400 will be described for a single vehicle. It should be appreciated that multiple vehicles can be supported by an embodiment of the system described herein.

Traffic status display process 400 may begin with the transmission of a request for updated traffic image data (task 402). This request is transmitted from the vehicle to its host remote command center. For this particular embodiment, the request is communicated as a cellular call from the vehicle to the remote command center. Such requests can be automatically transmitted according to a preset schedule, transmitted on demand under the control of the user, automatically transmitted based upon the location of the vehicle relative to a reference point (such as the nearest traffic camera or point of interest), or transmitted in accordance with other criteria. The request may indicate: the closest traffic camera relative to the location of the vehicle; the next five or ten (or any number) approaching traffic cameras relative to the location of the vehicle; all traffic cameras within a specified range relative to the location of the vehicle; all traffic cameras that are currently displayed on the onboard display element; all traffic cameras that are within five or ten (or any number) driving time minutes; or the like.

Traffic status display process 400 assumes that the remote command center receives the request transmitted during task 402. For this example, it is assumed that remote command center can receive updated images from the traffic cameras whenever desired and in a manner that is independent of any interaction between the remote command center and its supported vehicles. In other words, the remote command center can be suitably configured such that realtime or near realtime images that reflect current traffic conditions are available on demand. Thus, in response to a request for updated traffic image data, the remote command center sends updated traffic image data to the requesting vehicle, where the updated traffic image data originates from at least one traffic camera. Process 400 assumes that the vehicle receives this updated traffic image data (task 404). As mentioned above, the received traffic image data corresponds to a picture of at least one road section of interest. Upon receipt, the current traffic image data is stored by the onboard system (task 404). For this embodiment, task 404 stores a plurality of road section images corresponding to a respective plurality of different road sections or points of interest. Local storage of the most recent traffic image data allows the onboard system to quickly access and process pictures between updates.

The embodiment described herein utilizes the current location of the vehicle to determine when to display the images obtained from the traffic cameras. Accordingly, traffic status display process 400 obtains location data corresponding to the current location of the vehicle (task 406). As mentioned above, the location data may be provided by an onboard GPS system. Process 400 can then determine (task 408) the distance between the vehicle and the next closest road section, i.e., the next closest road section that is monitored by a traffic camera. During task 408, the system processor calculates the distance between the current location of the vehicle (obtained during task 406) and the static location of the next closest traffic camera, which is known a priori. This calculated distance can then be compared to a threshold distance (query task 410) to determine whether it is appropriate to display the road section image at this time. For this example, if the calculated distance is greater than or equal to the threshold distance, then process 400 checks whether it should update the traffic image data (query task 412). If an update is due, then process 400 can be re-entered at task 402 to transmit another request for traffic image data. If an update is not due, then process 400 can be re-entered at task 406 to obtain the new location of the vehicle and continue as described above.

If, however, the distance calculated during task 408 is less than the threshold distance, then traffic status display process 400 will trigger the display of a picture of the road section. The threshold distance, which may be set or selected by the user, enables the system to display a road section image before the vehicle actually reaches that road section. In practice, the threshold distance is selected to enable the driver to react to traffic conditions well in advance of actually reaching the monitored road section. For example, a threshold distance of five or more miles should allow the driver to change his or her route if necessary to avoid heavy traffic congestion. Referring again to FIG. 2, processor 202 and any corresponding logical elements, individually or in combination, are exemplary means for determining the distance between the current location and the road section. In addition, processor 202 and any corresponding logical elements, individually or in combination, are exemplary means for comparing the calculated distance to the threshold distance.

In certain embodiments, traffic status display process 400 displays a current map image on the onboard display element of the vehicle (task 414), as described above with reference to FIG. 3. For this particular embodiment, process 400 also selects one of the stored road section images and displays the selected road section image on the onboard display element (task 416). In practice, the selected road section image is the road section image that corresponds to the next closest road section, relative to the vehicle. As described above with reference to FIG. 4, the picture of the road section may be superimposed over at least a portion of the displayed map image.

This embodiment of traffic status display process 400 displays each road section image for a limited time period, which may be user-configurable. Thus, if the designated time period has elapsed (query task 418), then process 400 removes the picture of the road section from the onboard display element (task 420). As an example, the time period may be in the range of five to fifteen seconds. Alternatively (or additionally), removal of road section images can be responsive to an amount of distance traveled by the vehicle, the current distance between the vehicle and the respective traffic camera, or the like. In practice, removal of the road section image will result in the display of the normal map image (see FIG. 3).

Following task 420, traffic status display process 400 may check whether it should update the traffic image data (query task 422). If an update is due, then process 400 can be re-entered at task 402 to transmit another request for traffic image data. If an update is not due, then process 400 can be re-entered at task 406 to obtain the new location of the vehicle and continue as described above.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method of displaying traffic status information to a user of a vehicle, the method comprising:
receiving traffic image data corresponding to a picture of a road section; and
displaying the picture of the road section on an onboard display element of the vehicle.

2. The method of claim 1, further comprising:
obtaining location data corresponding to a current location of the vehicle;
determining a distance between the current location and the road section; and
comparing the distance to a threshold distance, wherein displaying the picture of the road section is triggered when the distance is less than the threshold distance.

3. The method of claim 1, further comprising transmitting a request for updated traffic image data from the vehicle to a remote command center, wherein receiving traffic image data is performed in response to the transmitting step.

4. The method of claim 1, further comprising removing the picture of the road section from the onboard display element after a designated time period.

5. The method of claim 1, further comprising displaying a map image on the onboard display element of the vehicle, wherein displaying the picture of the road section comprises superimposing the picture of the road section over the map image.

6. The method of claim 1, further comprising displaying a map image on the onboard display element of the vehicle, the map image comprising a graphical icon that identifies the road section.

7. The method of claim 1, further comprising displaying a map image on the onboard display element of the vehicle, the map image comprising a graphical icon that identifies a location of a source of the traffic image data.

8. A method of displaying traffic status information to a user of a vehicle, the method comprising:
storing a plurality of road section images corresponding to a respective plurality of different road sections;
selecting one of the plurality of road section images, resulting in a selected road section image; and
displaying the selected road section image on an onboard display element of the vehicle.

9. The method of claim 8, further comprising:
obtaining a current location of the vehicle;
determining, based upon the current location of the vehicle, a closest one of the plurality of different road sections; and
choosing, from the plurality of road section images, a next road section image that corresponds to the closest one of the plurality of different road sections, wherein selecting one of the plurality of road section images comprises selecting the next road section image.

10. The method of claim 8, further comprising receiving the plurality of road section images from a remote command center.

11. The method of claim 8, wherein the plurality of different road sections are sections of a road on which the vehicle is traveling.

12. The method of claim 8, further comprising:
receiving a plurality of updated road section images corresponding to the plurality of different road sections; and
storing the plurality of updated road section images.

13. The method of claim 8, further comprising displaying a map image on the onboard display element of the vehicle, wherein displaying the selected road section image comprises superimposing the selected road section image over the map image.

14. The method of claim 8, further comprising:
capturing the plurality of road section images from cameras located at the plurality of different road sections;
transmitting the plurality of road section images to a remote command center; and
sending the plurality of road section images to an onboard system of the vehicle.

15. A traffic status system for a vehicle, the system comprising:
a data communication module configured to receive traffic image data indicative of a picture of a road section;
a display driver coupled to the data communication module, the display driver being configured to process the traffic image data for display; and
a display element coupled to the display driver, the display element being configured to display the picture of the road section.

16. The system of claim 15, the data communication module being configured to transmit a request for updated traffic image data from the vehicle to a remote command center.

17. The system of claim 15, the display driver being configured to render a map image on the display element.

18. The system of claim 15, further comprising:
a traffic camera configured to capture the traffic image data; and
a remote command center configured to receive the traffic image data from the traffic camera, and configured to transmit the traffic image data to the data communication module.

19. The system of claim 15, the display driver being configured to remove the picture of the road section from the display element after a designated time period.

20. The system of claim 15, further comprising:
means for obtaining location data corresponding to a current location of the vehicle;
means for determining a distance between the current location and the road section; and
means for comparing the distance to a threshold distance, wherein the display driver initiates display of the picture of the road section when the distance is less than the threshold distance.
